(19) United States
(12) Patent Application Publication
(10) Pub. No.: US 2007/0278059 A1
(43) Pub. Date: Dec. 6, 2007

(54) System For Supplying Very Low Voltage Electrical Energy For An Electrical Traction Vehicle Comprising An Onboard Store Of Energy

(76) Inventor: Herve Afriat, Paris (FR)

Correspondence Address: SUGHRUE MION, PLLC, 2100 PENNSYLVANIA AVENUE, N.W., SUITE 800, WASHINGTON, DC, 20037, US

(21) Appl. No.: 10/590,418

(22) PCT Filed: Feb. 23, 2005
(86) PCT No.: PCT/FR05/00422

§ 371 Date: May 1, 2007

(30) Foreign Application Priority Data
Feb. 23, 2004 (FR) 0401802

(51) Int. Cl. B60M 3/04

(52) U.S. Cl. 191/29 R; 104/88.04

(57) ABSTRACT

The invention relates to a system for supplying very low voltage electrical energy for at least one electric traction vehicle (30) running on a track (20), and comprising: at least one very low voltage electric power system (10) installed directly next to the track (20); two parallel power supply rails (41, 42) or the like, that are adjacent or distant, a first rail (41) being connected to a terminal (11) of said power supply means (10) and the second rail (42) being connected to another terminal (12) of said power supply means (10); at least one onboard means for storing electrical energy (60) in the vehicle; and at least one onboard power supply means (80) that is joined to the means for collecting electrical energy (51, 52), and is connected both to the storage means (60) and the traction chain (70), such that the very low voltage power supply means (10) feeds the onboard power supply means (80) which, in turn, feeds the storage means (60) so that it stores electrical energy, to its full capacity, in the successive rolling phases.

### FIELD OF THE INVENTION

The present invention relates to a system for supplying extra low voltage electrical energy for electrical traction vehicles with onboard energy storage.

### STATE OF THE PRIOR ART

The term “extra low voltage” is used to mean voltages measured in tens of volts, unlike the traditional power supply systems for trams and trolleybuses in which the power supply features voltages measured in hundreds of volts.

In recent years, trams, fed by overhead contact lines, have been returning to the towns because of their many advantages, particularly that of allowing for heavy and regular passenger traffic, the fact that it is a surface transport means and that there are no exhaust gases.

The same applies to electrical traction vehicles with pneumatic tires, like trolleybuses.

However, the presence of overhead contact lines, which electrically feed these vehicles, have drawbacks, including:
dangers associated with the presence of a voltage of around 1000 V just a few meters above the ground in an area crowded with people,
access constraints for fire engines,
constraints associated with crossing crossroads, the height of the overhead lines here needing to be at least six meters above the ground,
the unsightly appearance produced by overhead lines in town centers, etc.

To do away with overhead lines, there are various possible solutions.

One of these solutions consists in using the conventional tram supply voltage, from 750 V to almost 1000 V DC, the vehicle supply being fed via a portion of electric line which is itself fed via the ground only when the vehicle is above said portion.

Another solution consists in equipping the vehicle with an energy storage device providing it with a certain autonomy between stations, recharging taking place when the vehicle is stopped at stations specially designed for this purpose.

Another solution, described in patent FR 2 825 666, consists in using a vehicle designed to be fed directly via low voltage rails not exceeding 60 V in DC voltage or 25 V in AC voltage.

However, these three solutions are not entirely satisfactory.

In the first solution, besides a not inconsiderable cost overhead associated with the installation of an underground electric line, the major risk associated with the voltage remains present and must be eliminated by regular and rigorous inspection of the safety systems that must remain reliable despite wear, climatic variations, and so on.

In the second solution, difficulties appear because of the still average performance characteristics of the storage devices, whether based on accumulator batteries or hypercapacitors.

As for the third solution, which in fact take up the principle of the miniature electric train fed directly by rails at extra low voltage, on the one hand, the available instantaneous power remaining modest, a limitation arises from the fact that the rail vehicle cannot exceed a few tons.

On the other hand, a new mechanical design of the rail vehicle becomes necessary in order to avoid short-circuiting the tracks, consequently leading to an incompatibility with the traditional track circuits.

Moreover, to operate, the traditional tram with catenary feed requires a number of substations, called rectifier substations, responsible for providing a power supply measured in hundreds, even thousands of amps at a voltage of 750 V DC. Said rectifier substations are disposed along the line every three, four or five stopping stations. The installed power is normally in the order of a megawatt for each rectifier substation. Furthermore, said rectifier substations occupy an area and a volume that is far from negligible, and sometimes constitute a real headache for the engineers when it comes to finding an available place. Furthermore, given the generally high price of real estate in towns, these rectifier substations can be particularly costly.

### OBJECT OF THE INVENTION

The object of the present invention is to remedy these drawbacks and, to this end, proposes a system for supplying extra low voltage electrical energy for electrical traction vehicles with onboard energy storage, which is satisfactory in respect of passenger transport capability, safety vis-à-vis electrical risks and energy efficiency.

Another object of the present invention is to significantly reduce the constraints associated with conventional rectifier substations.

Another object is to significantly simplify the infrastructure of a tram or trolleybus type transport line.

### SUMMARY OF THE INVENTION

The invention relates to a system for supplying extra low voltage electrical energy for at least one electrical traction vehicle running on a track, said vehicle being equipped with wheels rolling on said track, and at least one traction chain acting on the wheels and comprising, in a manner known per se, at least one electric motor and its control, said supply system being characterized in that it comprises:
at least one extra low voltage supply means installed in the immediate vicinity of the track,
two linear power supply elements, parallel to each other, adjacent or distant, of which a first is linked to a terminal of said power supply means and the second is linked to another terminal of said power supply means,
at least one first electrical energy collection means on board the vehicle and placed in moving contact with said first linear supply element,
at least one second electrical energy collection means also on board the vehicle and placed in moving contact with said second linear supply element,
at least one electrical energy storage means on board the vehicle, and
at least one onboard power supply means which is linked to said electrical energy collection means, and which is connected on the one hand to said storage means and on the other hand to said traction chain.

With this supply system according to the invention, said extra low voltage power supply means feeds said onboard power supply means, the latter in turn feeding said storage means so that it stores electrical energy, to its full capacity. This supply takes place in the following successive phases:

a) during the phase of coasting on the flat when the power demanded by the traction chain is modest, or even zero,

b) during the braking phase when there is also a recovery of electrical energy from the traction chain,

c) and during the stopping phase when the power demanded by the traction chain is zero, and

the electrical supply system according to the invention uses, not only the energy taken from the extra low voltage supply means, but also the electrical energy that has been stored in said phases (a, b, c) in said storage means to power the traction chain during the starting phase or on a gradient to be climbed, when the power demanded by the traction chain is relatively high, or when coasting without supply, and also the energy from the extra low voltage supply means in the other phases of motion.

The supply by linear supply elements, based on an extra low voltage supply means, presents no electrical risks to persons and, given said operating phases of the transport vehicle, of tram or trolleybus type in particular, provides the facility to store enough electrical energy in the storage means, provided for this purpose with adequate capacity, to cover the greatest electrical energy demands of the traction chain.

The linear power supply elements can be formed by rails, cables, rods or similar.

Said ails or linear electrical conductive elements are advantageously disposed on the ground, electrically insulated, parallel and separate from each other, or adjacent.

According to a first variant of the system according to the invention, applied to trams rolling on rolling rails, said linear supply rails are separate from the rolling rails. This is called a four-rail configuration.

According to a second variant of the system according to the invention for the same application, said supply rails are combined with the rolling rails. This is called a two-rail configuration.

According to a third variant of the system according to the invention for this application, one of the supply rails is electrically combined with at least one of the rolling rails, while the other supply rail is electrically separate from the rolling rails. This is called a three-rail configuration.

According to a particular feature of the system according to the invention, said extra low voltage supply means comprises a number of separate extra low voltage supply substations installed along the track, either between the rails or laterally, in the vicinity of the rails.

Said independent extra low voltage supply substations can be installed along the track at least at each stopping station, and can, if necessary, be interlinked in case of need, for example, if one of them was no longer powered.

According to another particular feature of the system, said storage means comprises accumulator batteries and hypercapacitors combined, and is dimensioned so as to cover the greatest energy demand of the traction chain, namely a starting of the vehicle followed by a gradient to be climbed.

According to another particular feature of the system, the onboard power supply means comprises at least one computer device controlling the energy distribution from the storage means to the traction chain, and in particular the recharging of the hypercapacitors, their selective discharging according to the energy demand, the rolling sequences and the line losses, and the recovery of braking energy from the vehicle by the storage means from the motor of the traction chain switched to generator mode.

The voltage delivered by the extra low voltage power supply means can be 48 V DC. Advantageously, one of the rails is raised to the +24 V DC potential, and the other to −24 V DC relative to the ground potential, but the voltage can be suited to the vehicle and to the track configuration.

For example, when the rails are buried to be out of reach of a person's touch, the voltage of the power supply means can reach 120 V, one of the rails being at the +60 V potential and the other at −60 V relative to the ground potential.

Naturally, the supply system according to the invention also feeds the auxiliary accessories of the vehicle, such as lighting, heating, air conditioning, etc.

### DESCRIPTION OF THE FIGURES

The invention is illustrated below by the use of non-limiting exemplary implementations and with reference to the appended drawings in which:

FIG. 1 represents a functional diagram of an embodiment of the supply system according to the invention applied to a tramway;

FIGS. 2a, 2b and 2c graphically illustrate various instantaneous powers, respectively, in the traction chain, in the storage means and in the extra low voltage supply means, when traveling along a route;

FIG. 3 represents a variant of the supply system according to the invention using an extra low voltage power supply substation placed at each stopping station and this all along the length of the line;

FIG. 4 is a circuit diagram of the power supply means on board the vehicle,

and FIGS. 5a and 5b show examples of electrical energy collectors for electrical traction vehicles with pneumatic tires, of the trolleybus type.

### DETAILED DESCRIPTION OF AN EMBODIMENT

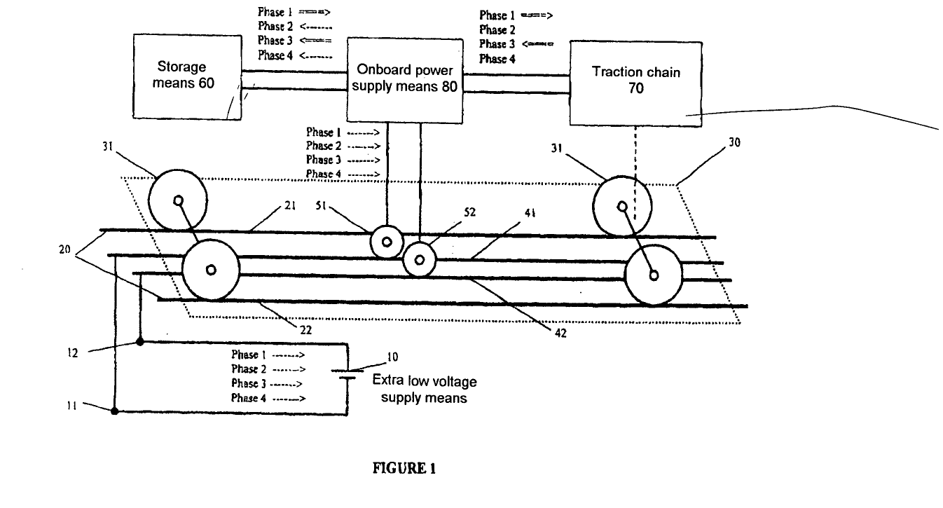

FIG. 1 represents a configuration of the supply system according to the invention, called a four-rail configuration, for a tramway-type rail vehicle. This system comprises an extra low voltage power supply means 10 installed in the immediate vicinity of at least one rail track 20, with two rolling rails 21, 22 on which the vehicle moves.

Between the rolling rails there are disposed two power supply rails 41, 42, parallel to each other, and to the rolling rails, of which the first 41 is linked to a terminal 11 of said power supply means and the second 42 is linked to another terminal 12 of said power supply means.

On the rail track there travels a rail vehicle 30 which comprises four wheels 31 linked to said vehicle. The rail vehicle has on board a first electrical energy collection means 51 and a second electrical energy collection means 52, the latter being placed in moving (sliding) contact respectively with the rail 41 and the rail 42.

The rail vehicle also has on board an electrical energy storage means 60, a traction chain 70 and an onboard power supply means 80 which is linked to said electrical energy collection means 51, 52, and which is electrically connected on the one hand to said storage means 60 and on the other hand to said traction chain 70.

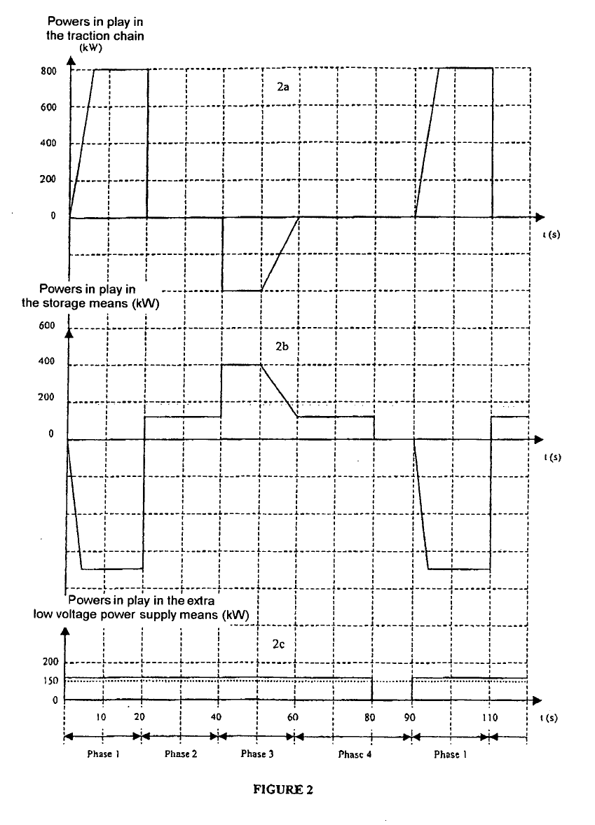

FIGS. 2a, 2b and 2c illustrate the travel along a route, between an origin station and a destination station. This path comprises four successive operating phases:
a starting or acceleration phase, denoted phase 1,
a cruising or coasting phase, denoted phase 2,
a braking or deceleration phase, denoted phase 3,
and a phase stopped at the destination station, denoted phase 4.

Phase 1 is that which demands the greatest energy because the rail vehicle must go from stopped to cruising speed. The instantaneous power demanded by the traction chain is high, normally measured in hundreds of kW for a tram or a trolleybus, in the present case 800 kW, 650 kW originating from the storage means 60 and 150 kW originating from the extra low voltage supply means 10.

Phase 2 is a speed maintenance phase. In this phase, the power demanded by the traction chain is normally zero on a flat route and remains modest even if it is maintained at a value that is sufficient to overcome friction.

Phase 3 is that in which, on the contrary, it is possible to recover energy when the vehicle is braking to a stop. The instantaneous power recovered from the traction chain can be high, measured in hundreds of kW for a tram or trolleybus, in the present case 400 kW originating from the traction chain 70.

Phase 4 is that in which the vehicle is stopped at the station and during which the passengers mount and dismount. The storage means 60 finishes its recharging, as shown at the time t=80 s in FIG. 2c. During this phase, the vehicle consumes no energy, except that which is always needed to power the auxiliaries of the vehicle (lighting, heating, air conditioning, etc.).

To return to FIG. 1, it shows single and double arrows showing the direction of the energy transfers between the various elements according to the various phases.

Phase 1 is the starting phase. The traction chain 70 demands a lot of energy represented by a double arrow outgoing from the supply means 80 and pointing towards the traction chain 70. This energy originates mainly from the storage means 60 represented by a double arrow incoming to the supply means 80 and secondly from the extra low voltage supply means 10 represented by a single arrow incoming to the supply means 80.

Phase 2 is the coasting phase during which the traction chain demands no energy. There is therefore no arrow towards the traction chain, but the storage means is recharged from the supply means 10 represented by a single arrow incoming to the supply means 80, then another arrow outgoing from the supply means 80 to go to the storage means 60.

Phase 3 is the braking phase during which there is recovery of energy from the traction chain 70 represented by a double arrow incoming to the supply means 80 and another double arrow incoming to the storage means 60. Here, the storage means 60 is recharged mainly by the recovery of energy on braking and secondly by the extra low voltage supply means 10, represented in FIG. 1 by a single arrow incoming to the supply means 80.

Phase 4 is the phase in which the vehicle is stopped at the station and during which the recharging of the storage means is completed and represented by a single arrow incoming to the supply means 80 and incoming to the storage means 60, and so on.

As FIGS. 2a, 2b and 2c show, an overall budget on the four phases reveals an instantaneous power that can be as high, for example, as 800 kW for a tram in the traction chain for phase 1, delivered by the storage means and the extra low voltage supply, while the average power over the entire route is significantly lower, for example 150 kW, corresponding to that of the extra low voltage supply means. Phase 3 corresponds to the energy recovered by the braking at a relatively high power, approximately 400 kW recovered by the storage means from the traction chain.

The average power delivered by the extra low voltage power supply means 10 is, for example, at a voltage of +48V and −48V DC on each of the supply rails.

The supply system according to the invention therefore operates generally as follows:
during the phases where the traction chain demands no electrical energy, the onboard power supply means 80 recharges the storage means 60 to its full capacity,
during the phases when the traction chain demands electrical energy, the onboard power supply means 80 will draw the necessary energy mainly from the storage means 60.

The storage means is dimensioned to be able to cover the greatest energy demand of the traction chain, namely a startup followed by a gradient to be climbed.

During the successive phases, the extra low voltage supply means 10 provides a roughly constant power. This power can even become zero if the vehicle is stopped and, apart from the auxiliaries (lighting, heating, air conditioning) that are also powered by the extra low voltage supply means 10, if the storage means has reached its maximum capacity.

An electrical pick-up configuration as illustrated by FIG. 1 has been described previously, but this pick-up can be performed according to other configurations.

According to one of these configurations not illustrated in the figures, the power supply rail 41 is combined with at least one of the two rolling rails 21 or 22 of the rail track, while the power supply rail 42 is separate from these rails. This configuration, called a third-rail configuration, requires an additional rail parallel to said rolling rails, but presents the advantage of being compatible with the traditional rail vehicles designed to short-circuit the rolling rails on which they run as they pass. This configuration is also compatible with the traditional track circuits.

According to another configuration not represented in the figures, the power supply rails 41 and 42 are combined with the rolling rails 21 and 22 of the track. This configuration, called a two-rail configuration, saves on the laying of two parallel rails for the power supply. However, in this case, the rail vehicle must not short-circuit said rails, as is normally the case, because this would amount to short-circuiting the extra low voltage supply means.

According to another configuration, there are no rolling rails, but only power supply rails 41, 42. This configuration, also called a two-rail configuration, is ideal for electrical vehicles with pneumatic tires such as trolleybuses and electric buses. Furthermore, because of the use of extra low voltage, the power supply rails can advantageously be adjacent so as to minimize on the civil engineering work required.

One of the advantages of the system according to the invention is that it makes it possible to do away with the overhead contact lines while optimizing on energy efficiency since energy recovery is performed on board each vehicle, independently of the other vehicles running on the track. It follows from this that the extra low voltage supply means is of relatively low power and small footprint compared to the traditional supply substations rated at around a megawatt.

The result is that an urban transport line can be designed to be powered by extra low voltage supply substations that are distributed along the track and that can be incorporated in the stopping stations because of their relatively modest power, which is of the order of a few tens of kW.

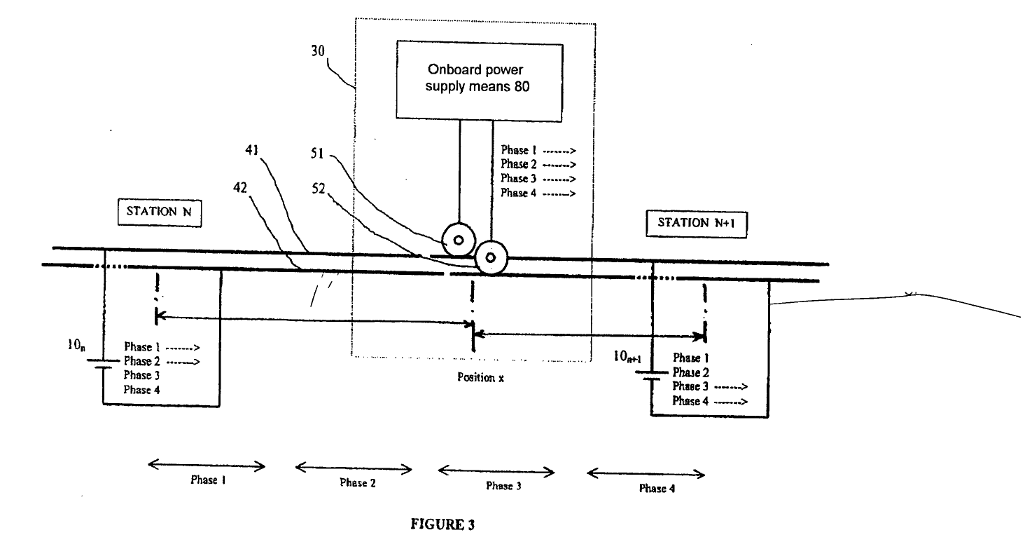

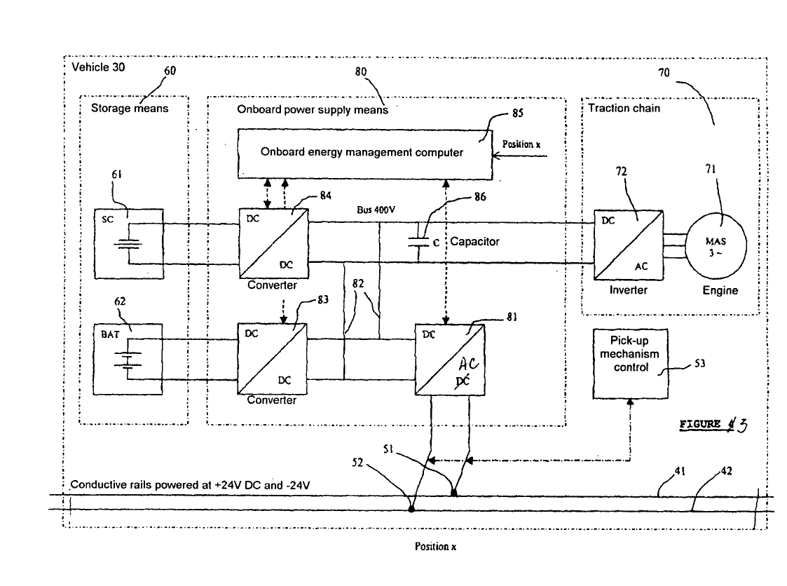

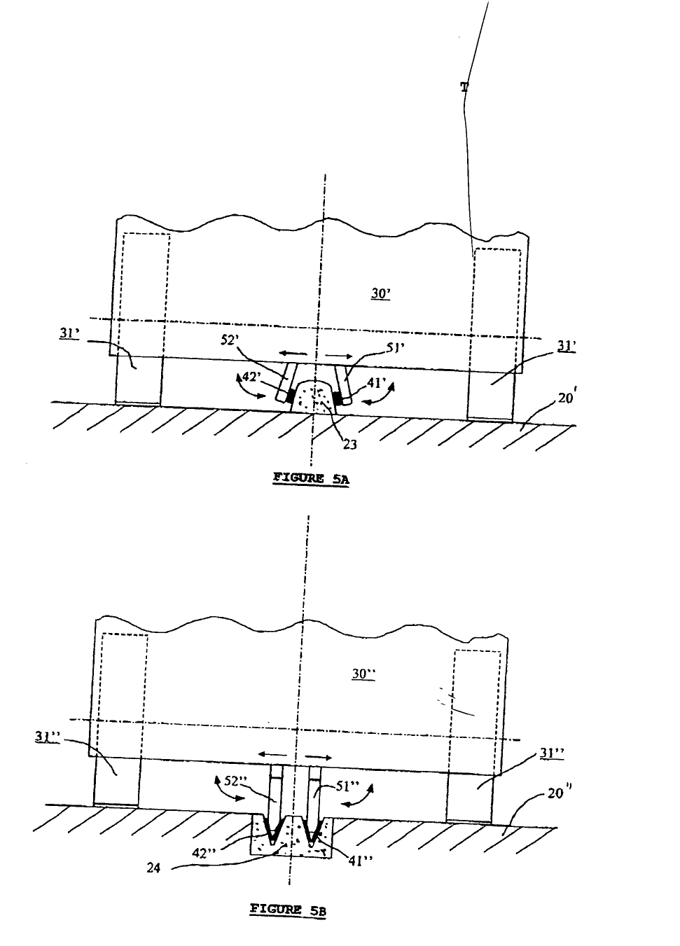

FIG. 3 thus illustrates an urban transport line comprising extra low voltage supply means or substations (10ₙ, 10ₙ₊₁, etc.) incorporated in the stopping stations (N, N+1, etc.) along the track. According to FIG. 3, the extra low voltage supply means of the station N denoted 10ₙ feeds the onboard power supply means 80 of the vehicle 30 leaving the station N to go on to the station N+1, for the phases 1 and 2, whereas the extra low voltage supply means of the station N+1 denoted 10ₙ₊₁ feeds the power supply means 80 for the phases 3 and 4. This configuration minimizes on the losses through Joule effect. In practice, the vehicle is theoretically at maximum speed at the midpoint between two stations at the maximum distance from the latter and in a reduced energy consumption state. Moreover, according to the profile of the track, it remains possible to add supply means between the stopping stations if necessary.

The system according to the invention would thus make it possible to save on the traditional rectifier substations rated with a power of approximately 1 megawatt, to replace them with extra low voltage supply means, which, although more numerous, are far more modest in terms of power, size and cost.

As an example, a three-phase 50 kVA/48 V DC transformer with rectifier bridges and protection devices occupies a volume less than a few cubic meters whereas a traditional rectifier substation occupies a volume of several hundreds of cubic meters.

These supply means could, as an example, advantageously be disposed under the track or under the surface occupied by each station, so optimizing on the area occupied by said supply means.

FIG. 4 is a schematic view of a circuit diagram of the onboard power supply means 80 on an electrical traction vehicle 30. This supply means, which is delimited by a chain dotted line box, is linked to the extra low voltage supply rails 41, 42 via the respective electrical energy collectors 51, 52, to the energy storage means 60 and to the traction chain 70.

Said storage means 60 comprise supercapacitor or hypercapacitor elements SC 61 and, where appropriate, a set of batteries BAT 62.

In the storage means, the benefit to be obtained from combining a set of batteries 62 with the set of supercapacitors 61 is optimizing the size of the set of supercapacitors while making it easier for the vehicle to run in occasional areas of partial autonomy, such as crossroads or diversions or on routes with steep climbs.

The traction chain 70 comprises an electric motor 71 driving the vehicle, for example, a three-phase asynchronous motor MAS-3˜ and a motor supply inverter 72.

The position of the electrical energy collectors 51, 52 on the rails 41, 42 is controlled by a collector positioning device 53 as will be seen in the text below.

The onboard power supply means 80 mainly comprises:
a first DC/DC electrical voltage converter 81 for raising the 48 V DC extra low voltage of the current picked up by the collectors 51, 52 to a voltage of 400 V DC, on a common supply bus 82. The 400 V DC voltage bus has connected to it a capacitor 86 responsible for keeping the voltage roughly constant during the switching transients of the solid-state converters;
a second DC/DC electrical voltage converter 83 linked to the batteries 62 and to the bus and transmitting the power supply from the batteries 62, to the common supply bus 82,
a third DC/DC reversible electrical voltage converter 84 suited to the supercapacitors 61 working in the 400 V to 800 V voltage range and delivering the power supply from the supercapacitors 61 to the bus 82 and recharging it from the bus 82 depending on the operating phases, and;
a main energy management computer 85 managing the operation of the vehicle in terms of running, speed, braking, stopping, etc. The main computer is linked to secondary computers, not shown, respectively, a computer for the supercapacitors 61, a computer for the batteries 62, a computer for the traction chain 70, a computer for the pick-up device 51, 52, 53, these computers being more specifically assigned to the dedicated management of these elements to which they are linked.

The onboard power supply means 80 also includes a discharging device (not shown) for the supercapacitors 61 and for the capacitor 86 for switching the supply to a safe mode for maintenance operations, for example.

The onboard power supply means 80 finally includes a battery charger device (not shown) directly fed by the pick-up device and selectively recharging the batteries 62 according to the control from the battery computer.

There now follows a Description of How the System of FIG. 4 Operates

With the supercapacitors assumed to be initially discharge, the positioning device 53 controls the placement of the collectors 51, 52 on the supply rails 41, 42. Then, the main computer controls the converters 81 and 84 in order to charge the supercapacitors 61 to their full capacity. The main computer 85 determines, by periodic measurement, the position x of the vehicle to compute the distance between the vehicle 30 and the nearest power supply means 10 and, based on this information, the computer 85 controls the first converter 81 to optimize the current pick-up, for example by reducing its intensity if it is remote from the extra low voltage supply means 10 and by increasing it when the vehicle approaches a next extra low voltage supply means so as to limit the line losses by Joule effect.

With the supercapacitors charged, according to the control set point of the vehicle supplied by the main computer, and therefore according to the current required by the traction chain 70, in the various rolling sequences of the vehicle, the main computer 85 will control the discharging of the supercapacitors 61 to the bus 82 for the starting phase in particular, over a relatively short period (10 to 20 seconds), to allow a high energy to be admitted to the traction chain 70 during this period.

The on-the-flat rolling phase of the vehicle can be performed by directly supplying the traction chain 70 via the extra low voltage supply rails 41, 42, without involving the batteries or the supercapacitors, while a variable recharging of the latter can be allowed according to the set points of their own computer and of the main computer 85.

The deceleration phase of the vehicle is controlled by the main computer 85 which controls the braking of the vehicle by switching the asynchronous motor 71 to generator mode. This makes it possible, when braking, to recover, in the supercapacitors 61, the high induced current supplied by the motor 71 switched to generator mode, the supercapacitors being capable of storing this energy. This procedure is carried out by switching the asynchronous motor 71 to generator mode, reversing the direction of the current in the inverter 72 and by reversing the direction of the current in the converter 84 interfacing with the supercapacitors 61, under the control of the main computer 85.

In a rolling phase on an upward gradient, the vehicle can continue to be powered more particularly by the batteries 62, under the set point of the main computer 85, which make it possible to add extra energy to the energy from the supercapacitors 61 and to the pick-up energy from the rails 41, 42 over a relatively long period and with a high overall capacity without in any way having an excessive dimensioning of the supercapacitors.

The stopping phase of the vehicle, for example at a stopping station and near to an extra low voltage supply means 10 of the station N, corresponding to a zero supply phase of the traction chain 70, will make it possible to fully recharge the supercapacitors 61 with a maximum current since it is closest to its source.

As an example, for a tram equipped with a motor with a power rating of 800 kW, it is possible to use a storage means 60 made up of fifteen 24 volt/136 Ah Cd/Ni batteries with a total capacity of 50 kWh for a weight of 1000 kg and combined with a supercapacitor with an overall capacity of 50 F/1000 V and used to half its overall capacity of 25.10⁶ J, and the total mass of which is approximately 3000 kg. This mass is relatively low compared to the overall mass of the vehicle which is approximately 80 tons.

The invention can also be applied to electrical traction vehicles with pneumatic tires such as trolleybuses or electric buses. This application is illustrated by FIGS. 5a and 5b.

In FIG. 5a, the vehicle 30′ on pneumatic tires 31′ carries in its lower part two collectors 51′, 52′ which overlap a non-conducting guide rail 23 fixed to the track 20′. The latter is provided with two external lateral sides on which are fixed two extra low voltage power supply rails 41′, 42′. The electrical energy collectors 51′, 52′ can move transversely under the vehicle (according to the arrows) and their movement relative to the center position thus allows for homing of the vehicle on the track 20′. They are also laterally retractable according to the arrows, to clear an obstacle or in an area with no extra low voltage supply, in temporary autonomy or temporary clearance mode.

In FIG. 5b, the vehicle 30″ with pneumatic tires 31′ carries in its lower part two collectors 51″, 52″ which are in contact with power supply rails 41″, 42″ disposed inside a non-conductive support 24 placed under the track 20″ and including a rainwater drain (not shown). These collectors are retracted over an obstacle and are also mobile transversely with homing of the vehicle.

If the rails 41″ and 42″ are made inaccessible to the touch, it is possible to use an extra low voltage, of 48 V and −48 V, even more relative to ground, which is equivalent to a supply voltage of 96 V giving twice the power compared to +24 V and −24 V.

There now follows a practical example of implementation of the supply system according to the invention in the particular case of an electric coach with a 50-seat capacity, with a gross vehicle weight rating of 13 tons. The traction chain is equipped with a 400 V asynchronous motor with a power rating of 120 kW. There is assumed a driving condition in which the starting phase up to 50 km/h is followed by a rise of 10 m over 500 m of travel fully loaded, which demands an energy of 3 Mjoules.

To this end, the storage means is implemented by the assembly of 2 times 24 150F/42 V UltraCap EPCOS modules forming a 12.5F/1000 V supercapacitor working for practical reasons in the 400 V to 800 V voltage range. Although it has a theoretical capacity of 6.25 Mjoules, the supercapacitor is used for 3 Mjoules, that is 50% of its theoretical capacity. It occupies an area of 5 m², a volume less than 2 m³ and represents a mass of 768 kg or 6% of the overall weight of the vehicle.

The powers installed at the stations are suited to the nature of the sections encountered between the stations. They are approximately 50 kVA.

In conclusion, the supply system according to the invention can be successfully applied to different types of electrical traction vehicles, in particular public transport vehicles, on rails or on pneumatic tires.

It makes it possible to design an urban transport line having the following major advantages:
no CO₂ emissions or urban atmospheric pollution,
no visual pollution,
an energy efficiency raised to its theoretical maximum, with energy recovery being done on board the vehicle,
an energy cost less than diesel or battery-powered electric buses,
lower civil engineering infrastructure cost,
lower power supply infrastructure cost,
optimized surface area on the ground, because there is no longer a need for specific places to install the traditional high-power rectifier substations.

1. A system for supplying extra low voltage electrical energy for at least one electrical traction vehicle (30) running on a track (20) and comprising:
wheels (31) linked to said vehicle and rolling on said track (20), and
at least one traction chain (70) of said vehicle acting on the wheels (31) and comprising, in a manner known per se, at least one electric motor and its control,
at least one extra low voltage power supply means (10) installed in the immediate vicinity of the track (20),
two power supply rails (41, 42) or similar power supply elements, parallel to each other, adjacent or distant, of which a first (41) is linked to a terminal (11) of said power supply means (10) and the second (42) is linked to another terminal (12) of said power supply means (10),
at least one first electrical energy collection means (51) on board the vehicle and placed in moving contact with said first rail (41),
at least one second electrical energy collection means (52) also on board the vehicle and placed in moving contact with said second rail (42),
at least one electrical energy storage means (60) on board the vehicle,
system characterized in that it comprises at least one onboard power supply means (80) which is linked to said electrical energy collection means (51, 52), and which is connected on the one hand to said storage means (60) and on the other hand to said traction chain (70), and which controls the energy distribution from the storage means (60) to the traction chain (70) and in particular the recharging of the storage means (60) and its selective discharging to feed the traction chain (70) according to the energy demand and the rolling sequences of the vehicle.

2. The system as claimed in claim 1, characterized in that said extra low voltage power supply means (10) feeds said onboard power supply means (80), the latter in turn feeding said storage means (60) so that it stores electrical energy, to its full capacity, in the following successive phases:
a) during the phase of coasting on the flat when the power demanded by the traction chain (70) is modest, or even zero,
b) during the braking phase when there is also a recovery of electrical energy from the traction chain (70),
c) and during the stopping phase when the power demanded by the traction chain (70) is zero,
said onboard power supply means (80) using, in addition to the energy taken from the extra low voltage supply means (10), the electrical energy that has been stored in said phases (a, b, c) in said storage means (60) to power the traction chain (70) during the starting phase or on a gradient to be climbed, when the power demanded by the traction chain is relatively high, or when coasting without extra low voltage supply, and the energy from the extra low voltage supply means (10) in the other phases of motion.

3. The system as claimed in claim 1 or 2, characterized in that said extra low voltage supply means (10) comprises a number of extra low voltage supply means (10ₙ, 10ₙ₊₁, etc.) installed along the track (20), either between the rails, or in the immediate vicinity, independent or interlinked.

4. The system as claimed in either of the preceding claims, characterized in that the voltage delivered by the power supply means (10) is 48 volts DC, one of the power supply rails (41) being at +24V and the other (42) at −24V.

5. The system as claimed in any one of the preceding claims, characterized in that said storage means (60) comprises hypercapacitors (61) possibly combined with batteries (62), or batteries and is dimensioned so as to cover the greatest energy demand of the traction chain (70), namely a starting of the vehicle followed by a gradient to be climbed, and, possibly, rolling in partial autonomy mode.

6. The system as claimed in one of the preceding claims, characterized in that the onboard power supply means (80) comprises at least one computer device (85) controlling the energy distribution from the storage means (60) to the traction chain (70), and in particular the recharging of the hypercapacitors (61), their selective discharging to feed the traction chain (70) according to the energy demand, the rolling sequences and the line losses, and the recovery of braking energy from the vehicle by the storage means (60) from the motor of the traction chain (70) switched to generator mode.

7. The system as claimed in claim 6, characterized in that the onboard power supply means (80) comprises:
a first DC/DC electrical voltage converter (81) for raising the 48V DC extra low voltage of the current picked up by the collectors (51, 52) to a voltage of 400 V DC, on a common supply bus (82);
a second DC/DC electrical voltage converter (83) linked to the batteries (62) and to the bus (82) and transmitting the power supply from the batteries (62) to the common supply bus (82),
a third DC/DC reversible electrical voltage converter (84) suited to the supercapacitors (61) working in the 400 V to 800 V voltage range and delivering the power supply from the supercapacitor (61) to the bus (82) and recharging it from the bus (82) depending on the operating phases;
a main energy management computer (85) managing the running, speed, braking and stopping operation of the vehicle (30), the main computer (85) being linked to secondary computers, respectively, a computer for the supercapacitors (61), a computer for the batteries (62), a computer for the traction chain (70), a computer for the pick-up device (51, 52, 53), these computers being more specifically assigned to the dedicated management of the elements to which they are linked;
a safety discharging device for switching the onboard power supply means to a safe mode for maintenance operations, and
a battery charger device directly fed by the pick-up device (51, 52, 53) and selectively recharging the batteries (62) according to the control from the battery computer.

8. The system as claimed in claim 7, characterized in that the main computer (85) determines, by periodic measurement, the position x of the vehicle to compute the distance between the vehicle (30) and the nearest power supply means (10) and, based on this information, the computer (85) controls the first converter (81) to optimize the current pick-up, for example, by reducing its intensity if it is remote from the extra low voltage supply means (10) and by increasing it when the vehicle approaches a next extra low voltage supply means so as to limit the line losses by Joule effect.

9. The system as claimed in any one of the preceding claims, characterized in that said vehicle (30) is a rail vehicle running on a rail track (20), the rolling rails of which (21, 22) can be combined, at least one, with the power supply rails (41, 42), or are separate from the latter.

10. The system as claimed in any one of claims 1 to 8, characterized in that said vehicle is a vehicle with pneumatic tires (30′, 30″).

11. The system as claimed in claim 10, characterized in that said electrical energy collection means (51′, 52′; 51″, 52″) are disposed under the vehicle (30′, 30″), being transversely mobile to accompany the vehicle (30′, 30″) on the track (20′, 20″), and can be retracted over an obstacle or out of the power supply rails (41′, 42′; 41″, 42″).

12. The system as claimed in claim 10, characterized in that the track (20′, 20″) comprises a vehicle guide rail (30′, 30″).
